(19) United States
(12) Patent Application Publication
(10) Pub. No.: US 2006/0204877 A1
(43) Pub. Date: Sep. 14, 2006

(54) Developing agent

(75) Inventor: Koichi Kuroyama, Kawasaki-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/246,477

(22) Filed: Oct. 11, 2005

(30) Foreign Application Priority Data
Mar. 8, 2005 (JP) 2005-064243

(51) Int. Cl. G03G 9/08

(52) U.S. Cl. 430/108.6; 430/108.7

(57) ABSTRACT

A developing agent including an additive added to adhere on the surface of a toner particle, wherein the additive comprises a first silica whose primary particle has a first mean volume diameter ranging from 10 to 15 nm, and a second silica whose primary particle has a second mean volume diameter which is larger than the first average particle diameter, a coverage of the first silica to the toner particle is confined within the range of 30 to 50%, and a ratio of projecting area of the second silica to projecting area of the first silica is confined within the range of 70 to 120%.

### CROSS-REFERENCE TO RELATED APPLICATIONS

This application is based upon and claims the benefit of priority from prior Japanese Patent Application No. 2005-064243, filed Mar. 8, 2005, the entire contents of which are incorporated herein by reference.

### BACKGROUND OF THE INVENTION

1. Field of the Invention

This invention relates to a developing agent to be employed in an image-forming apparatus of electrophotographic or electrostatic printing system.

2. Description of the Related Art

In a copying machine where a toner recycling system is adopted so that the toner left remained on a photoreceptor after transcription is enabled to re-use as a recycle toner, there is a problem that silica is caused to remove from the surface of the recycle toner, thereby reducing the quantity of electrification thereof as compared with that of the fresh toner to be supplied from a cartridge. Because of this, there will be raised a problem that the scattering of toner is promoted when the recycle toner is employed. As a means for preventing the scattering of toner, there is known a method of increasing the content of hydrophobic silica. However, a large quantity of hydrophobic silica will be required to be used in order to obtain a sufficient effect, which in turn results in an increase of quantity of electrification, thus raising other problems that it is impossible to obtain a sufficient degree of image concentration, a half-tone image would become irregular in quality, and the denseness of solid image may be deteriorated. Further, there are also problems that the quantity of electrification may be caused to differ greatly between low humidity and high humidity, and fogging as well as the scattering of toner may be promoted as the distribution in quantity of electrification is enlarged under low humidity.

In view of these problems, there has been proposed a method for securing image density through the co-use of titanium oxide as an additive as set forth in JP Laid-open Patent Publication (Kokai) No. 2001-147547. This method however is accompanied with problems that titanium oxide that has been removed from the surface of toner particle is permitted to accumulate in the recycle toner during the operation of high-speed copying machine which is designed for long life operation, thereby deteriorating the electrostatic property of toner particle due to this accumulated titanium oxide and hence promoting the scattering of toner.

As described above, although it is possible to control the quantity of electrification of recycle toner through the employment of a large quantity of additive, it will raise another problem that the formation of filming onto a photoreceptor is caused to increase. Especially, silica having a small particle diameter will be enabled to easily adhere onto the surface of photoreceptor. When a toner is permitted to deposit over this deposited silica in the course of long-term operation of copying machine, it will become a cause for generating a defective image such as an image having spots or streaks thereon.

As for the means for preventing the aforementioned filming, a metal soap may be externally applied to the surface of toner so as to reduce the frictional coefficient between a photoreceptor and a cleaning blade. However, since the metal soap tends to accumulate in a developing device, the fluidity of developing agent would be decreased and, due to this decrease of fluidity, the image of half-tone would be roughened and the denseness of solid image would be deteriorated. Although it is possible to prevent the deterioration in fluidity of developing agent by increasing the content of hydrophobic silica and titanium oxide in an attempt to overcome these problems, the increase of the content of silica would result in an increase in quality of electrification and the increase of the content of titanium oxide would result in promotion of scattering of toner, thus making it difficult to overcome all of these problems.

### BRIEF SUMMARY OF THE INVENTION

An object of one embodiment of the present invention is to provide a developing agent which is stable in electrification throughout the life thereof and capable of forming an excellent image without generating fogging or scattering of toner even if it is employed in an image-forming apparatus provided with a recycling mechanism.

The developing agent according to one embodiment of the present invention comprises a toner particle containing a coloring material and a binder resin; and an additive added to adhere a surface of the toner particle; wherein the additive comprises a first silica whose primary particle has a first average particle diameter ranging from 10 to 15 nm, and a second silica whose primary particle has a second average particle diameter which is larger than the first average particle diameter; a coverage of the first silica to the toner particle adhered with the additive is confined within the range of 30 to 50%; and a ratio of projecting area of the second silica to projecting area of the first silica is confined within the range of 7.0 to 120%.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically illustrating one example of the construction of image-forming apparatus to be employed in the present invention; and

FIG. 2 is a perspective view for illustrating the recycling mechanism to be employed in the device shown in FIG. 1.

### DETAILED DESCRIPTION OF THE INVENTION

The developing agent according to one example of the present invention comprises a toner particle containing a coloring material and a binder resin, and an additive added to adhere the surface of the toner particle.

The additive to be employed comprises two kinds of silica differing in average particle diameter from each other. A first silica is featured in that the primary particle thereof has a first average particle diameter ranging from 10 to 15 nm. A second silica is featured in that the primary particle thereof has a second average particle diameter which is larger than the first average particle diameter. Volume 50% diameter is called herein average particle diameter.

The coverage of the first silica to the surface of toner particle is confined within the range of 30 to 50%. Further, a ratio of projecting area of the second silica to projecting area of the first silica is confined within the range of 70 to 120%.

By covering the surface of toner particle with the first silica whose primary particle has a first average diameter ranging from 10 to 15 nm at a coverage of 30 to 50%, it is possible to obtain a sufficient quantity of electrification. Further, by covering the surface of toner particle in this manner, it is possible to prevent the deterioration of electrification on the occasion of recycling toner and to minimize the scattering of toner. Further, by making use of the second silica whose primary particle has a larger average particle diameter than that of the first silica and by confining the ratio of projecting area of the second silica to projecting area of the first silica to the range of 70 to 120%, it is possible to enhance the transferring property of toner, and to enhance the electrification of toner due to floating silica, thereby making it possible to prevent the deterioration of denseness of solid image as well as the non-uniformity in concentration of image.

As described above, according to the example of the present invention, it is possible, due to co-use of two kinds of silica differing in average particle diameter, to enhance the transferring property of toner and to improve the quality of image. Further, the developing agent according to the example of the present invention is especially advantageous for use in an image-forming apparatus having a recycling mechanism.

If the average diameter of the first silica is less than 10 nm, it would lead to the deterioration in concentration of image or the generation of filming of photoreceptor. On the other hand, if the average diameter of the first silica exceeds over 15 nm, it would invite various disadvantages such as the increase of scattering of toner or the deterioration of conveying property of developing agent.

If the coverage of toner particle by the first silica is less than 30%, the scattering of toner would be more likely caused to generate. On the other hand, if the coverage of toner particle by the first silica exceeds over 50%, it would invite an increase in quantity of floating silica in a developing agent without being adhered to toner particle, thereby generating the filming of photoreceptor and deteriorating image density.

Preferably, the toner particle to be employed should have an average particle diameter ranging from 7 to 10 μm.

A preferable range of average particle diameter of the second silica would be 16 to 25 nm.

If the average particle diameter of the second silica is less than 16 nm, it would lead to the generation of non-uniformity in concentration of image and to an increased scattering of toner. On the other hand, if the average particle diameter of the second silica exceeds over 25 nm, it would more likely invite the generation of filming of photoreceptor.

If the ratio of projecting area of the second silica to the projecting area of the first silica is less than 50%, it would lead to the generation of non-uniformity in concentration of image and to the deterioration in concentration of image. On the other hand, if the ratio of projecting area of the second silica to the projecting area of the first silica exceeds over 70%, it would more likely invite the generation of filming of photoreceptor and the deterioration in concentration of image.

Since the employment of the second silica having a large average particle diameter tends to become a cause for the generation of filming, it is preferably in the present invention to apply a metal soap to the surface of toner particle. However, if the quantity of metal soap to be applied thereto is too large, the fluidity of developing agent would more likely be deteriorated. Therefore, it is preferable that the quantity of metal soap to be applied to the surface of toner particle is confined to the range of 0.05 to 0.15% by weight based on a total weight of toner particle.

If the quantity of metal soap is less than 0.05% by weight, it would be insufficient to achieve the effect of preventing the generation of filming. On the other hand, if the quantity of metal soap exceeds over 0.15% by weight, it would lead to the adhesion of carrier, giving rise to the generation of defective image.

As for specific examples of metal soap, it is possible to employ, for example, non-alkaline metal salts of fatty acid such as zinc stearate, calcium stearate, magnesium stearate, ammonium stearate, etc.

Further, in order to prevent the deterioration of fluidity of toner due to the employment of metal soap, it may be preferable to apply titanium oxide to the surface of toner particle. Since titanium oxide is liable to deposit in a developing agent in the case where a developing device of toner recycle system is employed and hence titanium oxide may likely become a cause for electrification failure as the employment of developing agent is repeated, the application of titanium oxide to the surface of toner particle should preferably be confined within the range of 1.5 to 2.5 parts by weight, more preferably about 2 parts, per part by weight of metal soap. If the addition of titanium oxide is less than 1.5 parts by weight, the conveying property of developing agent would be deteriorated, giving rise to the generation of non-uniformity in concentration of image or the adhesion of carrier. On the other hand, if the addition of titanium oxide exceeds over 2.5 parts by weight, it would likely lead to an increase of scattering of toner and the generation of filming of photoreceptor.

Further, the mixing ratio of titanium oxide should preferably be confined within the range of 0.1 to 0.3% by weight based on a total weight of toner particle. If the mixing ratio of titanium oxide is less than 0.1% by weight, it would likely lead to the deterioration in concentration of image. On the other hand, if the mixing ratio of titanium oxide exceeds over 0.3% by weight, titanium oxide is liable to deposit in a developing agent in the recycle system, presenting likelihood of promoting the scattering of toner.

An average particle diameter of titanium oxide should preferably be confined within the range of 14 nm to 25 nm.

The co-use of metal soap and titanium oxide in addition to the aforementioned silica is advantageous in that the filming of photoreceptor can be prevented, thus making it possible to obtain stabilized electrification and stabilized image properties.

As for the binder resin to be incorporated into the developing agent, it is possible to employ, for example, polyester resin, polystyrene resin, styrene/acrylate copolymer, polyester/styrene/acrylate copolymer, epoxy resin, etc.

As for the wax, it is possible to employ, for example, natural wax such as rice wax, carnauba wax, etc.; petroleum wax such as paraffin wax, etc.; and synthetic wax such as fatty ester, fatty amide, low-molecular polyethylene, low-molecular polypropylene, etc.

As for the coloring material, it is possible to employ, for example, carbon black, organic or inorganic pigments or dyes. If required, it is also possible to incorporate a charge conditioner.

The toner particle of developing agent can be manufactured according to various manufacturing methods such as grinding method, polymerization method, etc.

In the case of the grinding method for example, a coloring material and a binder resin are melted and kneaded to obtain a kneaded mixture, which is then dried, coarsely pulverized, finely pulverized and classified to obtain a toner particle.

To this toner particle, the aforementioned first and second silica are added by making use of a high-speed rotary mixer such as Henschel mixer, thereby adhering the first and second silica onto the surface of toner particle. With respect to the quantity and mixing conditions of these first and second silica to be applied to the toner particle, they can be determined depending on the coverage that can be calculated from the measured value of the projecting area of toner. For example, when the coverage of the surface of toner particle by the first silica is confined within the range of 30-50% and a total of the projecting area of the first silica and the projecting area of the second silica is assumed as being 100%, the ratio of projecting area of the second silica can be adjusted so as to make it fall within the range of 70-120% through the control of the particle size of the primary particle of the second silica, through the control of the adding amount of the second silica, or through the control of particle diameter of toner particle.

If required, it is also possible to incorporate metal soap, titanium oxide, etc. into the toner.

As for the developing agent of the example of the present invention, it is possible to employ a two-component developing agent comprising a mixture of a toner and a carrier.

As for the carrier, it is possible to employ ferrite particle covered with a resin mainly consisted of silicone resin.

As for the average particle diameter of the carrier, it should preferably be confined within the range of 45 μm to 65 μm.

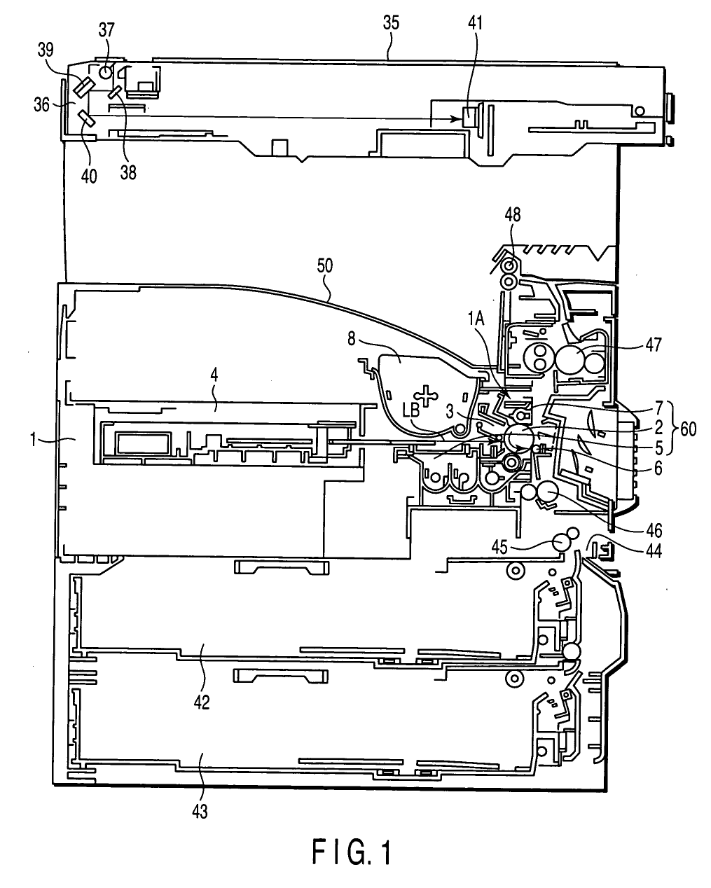

One example of the internal structure of the image-forming apparatus to which the developing agent of the present invention can be applied is schematically illustrated in FIG. 1.

Referring to FIG. 1, reference number 1 represents the main body of copying machine wherein an image-forming portion 1A is disposed on one side of central portion of this main body. At this image-forming portion 1A, a photoreceptor drum 2 is disposed as an image carrier which is made rotatable in the direction of arrow. Around the photoreceptor drum 2, there are disposed successively, mentioning in the rotational direction of photoreceptor drum 2, an electrification charger 3 for electrifying the surface of photoreceptor drum 2, a laser unit 4 for forming an electrostatic latent image on the surface of the photoreceptor drum 2, a developing device 5 for developing the electrostatic latent image on the surface of photoreceptor drum 2 by making use of a toner, a transferring roller 6 for transferring the image of toner on the photoreceptor drum 2 to a sheet of paper, and a cleaning device 7 for removing residual toner left remained on the surface of photoreceptor drum 2.

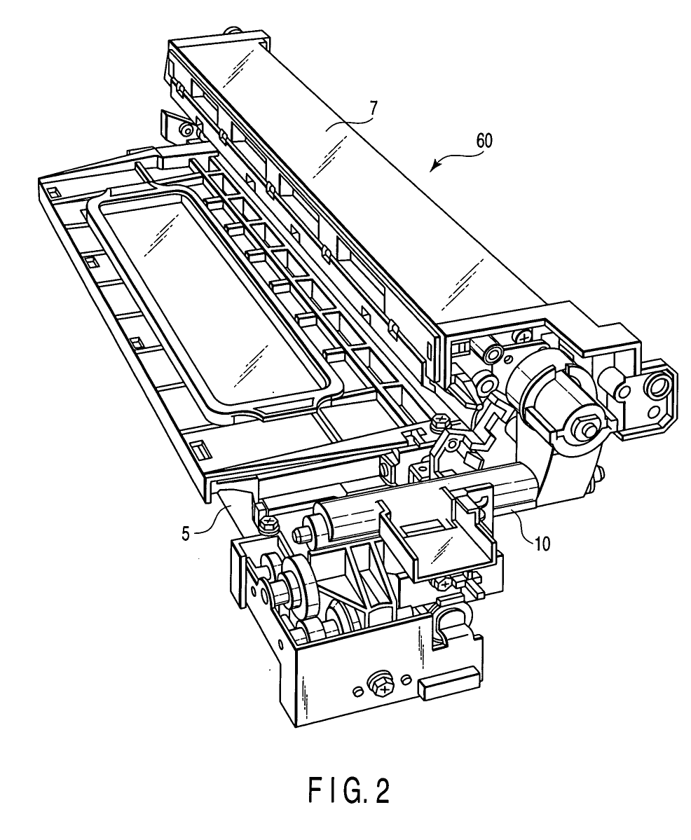

Further, a toner supply container 8 is disposed as a supply means over the developing device 5, and is removable from the image forming apparatus. In the developing device 5, a two-component developing agent consisting of a carrier and a toner is placed in the developing device 5. As shown in FIG. 2, this developing device 5 is connected, through a toner recovery mechanism 10, with the cleaning device 7.

A processing cartridge 60 includes the photoreceptor drum 2 and the developing device 5 which are held integrally, and is removable from the main body of copying machine.

A manuscript-mounting table 35 is disposed on the top surface of the main body 1 of copying machine. On the underneath of the manuscript-mounting table 35, there is disposed a scanner 36 for performing the exposure of manuscript which is placed on the manuscript-mounting table 35. The scanner 36 is constituted by a light source 37 for irradiating the manuscript with light, a first reflection mirror 38 for reflecting the light reflected from the manuscript in a predetermined direction, a couple of second and third reflection mirrors 39 and 40 for successively reflecting the light reflected from the first reflection mirror 38, and a light receptor 41 for receiving the light reflected from the third reflection mirror 40.

On the underneath of the main body 1 of copying machine, there are disposed, in two stages, a couple of paper-feeding cassettes 42 and 43, from which sheets of paper are supplied. These sheets of paper are conveyed upward through a conveying system 44. This conveying system 44 includes a pair of conveying rollers 45, a pair of resist rollers 46, an image transferring portion, a pair of fixing rollers 47, and a pair of paper discharge rollers 48.

On the occasion of forming an image, light is irradiated from the light source 37 to a manuscript placed on the manuscript-mounting table 35. This light is reflected from the manuscript and received through the first, second and third reflection mirrors 38, 39 and 40 by the light receptor 41, thereby enabling the image of manuscript to be read out. Based on this read information, a laser beam LB is irradiated from the laser unit 4 onto the surface of photoreceptor drum 2. The surface of photoreceptor drum 2 is electrified into negative polarity by means of electrification charger 3. Through the irradiation of laser beam LB from the laser unit 4, the photoreceptor drum 2 is exposed. As a result, at the region corresponding to the image portion of manuscript, the surface potential of the photoreceptor drum 2 is caused to approach to zero depending on image density, thereby forming an electrostatic latent image. This electrostatic latent image is placed, through the rotation of the photoreceptor drum 2, to face the developing device 5. Under this condition, a toner supplied through the carrier from the developing device 5 is enabled to adsorb onto the photoreceptor drum 2, thereby creating a visible image.

At this moment, a sheet of paper is fed and conveyed from the paper-feeding cassette 42 or 43 and, after being aligned in position by means of the resist rollers 46, introduced into an image-transferring portion between the transfer roller 6 and the photoreceptor drum 2, thereby enabling the visible image on the photoreceptor drum 2 to be transferred onto the paper which has been electrified into positive polarity.

The paper having this transferred image is conveyed to the fixing rollers 47 and then, pressure and heat are applied to the paper to fix the image onto the paper. After this fixing process, the paper is discharged through the paper discharge rollers 48 onto a paper discharge tray 50.

On the other hand, the toner that could not be transferred onto the paper at the image-transferring portion and left remained on the surface of the photoreceptor drum 2 is removed by means of the cleaning device 7, after which the residual toner is returned by means of the recovery mechanism 10 to the developing device 5 so as to be re-used as a recycle toner. Meanwhile, when the toner in the developing device 5 is consumed due to the aforementioned developing process, a fresh toner is supplied from the toner supply vessel 8. In this manner, the recycle toner and the fresh toner are mixed together in the developing device 5 to form a mixed toner which is then fed for the developing process.

Next, the present invention will be specifically explained with reference to the following examples.

### EXAMPLE 1

A toner particle material having the following composition was prepared.

Carbon black (coloring material): 5 parts by weight

Polyester (binder resin): 88.5 parts by weight

Fe-containing azo dye (load current controlling agent): 1.5 parts by weight

Low molecular weight polyethylene wax: 5 parts by weight

These components were preliminarily mixed together by means of Henschel mixer to obtain a mixture which was then melted and kneaded to obtain a kneaded material.

This kneaded material was dried and subjected to coarse pulverization and fine pulverization by means of jet mill to obtain a pulverized matter.

The pulverized matter thus obtained was classified by means of air classifier to obtain a toner particle having an average particle diameter ranging from 7 to 10 μm.

To the surface of the toner particle thus obtained, 0.3 part by weight of silica (S1) having, as primary particle, an average particle diameter of 10 nm was applied so as to enable the surface of toner to have a coverage (X) of 30%. At the same time, by making use of Henschel mixer, silica (S2) having, as primary particle, an average particle diameter of 16 nm was mixed with the toner for 5 minutes so as to enable the ratio (Y) of total projecting area thereof to become 120% of a total projecting area of the silica (S1) to obtain a mixture, which was then sieved by means of a 200 mesh sieve to obtain an aimed toner.

The projecting area was measured, by means of TEM, Transmission Electron Microscope, for example, from an average value of the cross-sectional area of silica.

Herein, the surface area X and the ratio of projecting area Y can be determined from the following theoretical formula.

The calculation of the coverage X of the surface of toner by the silica (S1) to be applied to the surface of toner:

The surface area (A) of toner particle was calculated from the following formula (1) on the assumption that the toner particle having an average particle diameter (Rt) was spherical.
A=4π(Rt/2)² (1)

A total projecting area (B) of the silica (S1) was determined from the following formula (2) representing the product to be obtained by multiplying the number (n) of the silica (1) adhering to a single piece of toner particle by the projecting area (S) of a single piece of silica to the toner particle.
B=nS (2)

The number (n) of the silica (1) was determined from the following formula (3).
n=(Dt/Df)(Rt/Rf)³{c/(100−c)} (3)

wherein c is a ratio (%) of the silica (S1) to the weight of toner; Dt is a density of toner particle (g/cm²); Df is a density of silica (g/cm²); Rt is an average particle diameter (cm) of toner particle; and Rf is an average particle diameter (cm) of the silica (S1).

By the way, the density of silica employed was 2.2 (g/cm²). Further, the density of titanium oxide was 4.0 (g/cm²).

The coverage X of the surface of toner by the first silica (S1) to be applied to the surface of toner can be determined from the following formula (4). Likewise, the coverage X of the surface of toner by the second silica (S2) can be determined from the following formula (4).
X=A/B×100 (4)

With respect to the ratio between the silica S1 and the silica S2 to be applied to the surface of toner, it can be determined from the following formula (5).
Y=Projecting area of the second silica (S2)/Projecting area of the first silica (S1) (5)

Then, 0.05% by weight of zinc stearate as a metal soap and 0.1% by weight of titanium oxide (which was twice as large as the weight of metal soap) were added to the toner particle having silica adhered thereto and mixed together by means of Henschel mixer to obtain a toner where these additives were adhered to the surface of toner particle.

5 parts by weight of this toner was added to 95 parts by weight of ferrite particle covered with silicone resin and mixed together by means of tumbling mixer to obtain a two-component developing agent.

The developing agent thus obtained was placed in a developing device of image-forming apparatus having a recycle mechanism as shown in FIGS. 1 and 2 for example, and the copying of image was repeated 500000 times.

The copies of image obtained by making use of this developing agent was subjected to various tests on image density, non-uniformity in concentration of image, the scattering of toner, the filming of photoreceptor, and developing agent conveying property as follows.

With respect to image density, it was measured by making use of a Macbeth densitometer and evaluated it as follows. When image density of a patch portion (i.e. 1.0) of the original pattern was more than 1.10 after the copying, it was identified as ◯; when this concentration of image after the copying was within the range of 1.00 to 1.10, it was identified as Δ; and when this concentration of image after the copying was less than 1.00, it was identified as X.

With respect to the non-uniformity in concentration of image, it was measured in the same manner as the measurement of the aforementioned image, thereby measuring difference in concentration of image among three regions of a patch portion of the original pattern, i.e. a front side, a central portion and a rear side to the main body of copying machine. When this difference in concentration was less than 0.15, it was identified as ◯; when this difference in concentration was confined within the range of 0.15 to 0.25, it was identified as Δ; and when this difference in concentration was more than 0.25, it was identified as X.

With respect to the scattering of toner, the contamination of paper was visually evaluated as follows. Namely, when the image was free from contamination by the toner or from dirt, it was identified as ◯; when the image was contaminated by the toner or dirt, it was identified as X.

With respect to the filming of photoreceptor, it was evaluated on a solid image, wherein when the solid image was free from white spot (1 mm or more in size), it was identified as ◯; when the number of white spot on the solid image was 1 to 10, it was identified as Δ; and when the number of white spot on the solid image was 11 or more, it was identified as X.

With respect to the conveying property of developing agent, the fluidity of developing agent in the developing device was measured. As a measuring apparatus, a bulk specific gravity measuring apparatus manufactured by Kuramochi Scientific Equipments Manufacturing Co. was employed. In this case, the time required for enabling 50 g of developing agent to completely fall was measured. When it took 60 to less than 120 seconds, it was identified as ◯; when it took 60 to 120 seconds, it was identified as Δ; and when it took more than 150 seconds, it was identified as X.

As a result, the developing agent obtained in this example indicated satisfactory results on all of these tests on image density, non-uniformity in concentration of image, the scattering of toner, the filming of photoreceptor, and developing agent conveying property.

Following Table 1 shows, as the features of each of additives, the average particle diameter of the primary particle of the first silica particle (S1); the coverage (X) of the surface of the first silica particle on the surface of toner particle; the average particle diameter of the primary particle of the second silica particle (S2); the ratio of projecting area (Y) of the second silica particle (S2) to the first silica particle (S1) to be added to the surface of toner particle; the quantity of metal soap to the weight of toner; and the quantity of titanium oxide to the weight of toner.

Following Table 2 illustrates the results of the aforementioned tests.

### EXAMPLES 2 TO 8

Various kinds of developing agents were prepared in the same manner as in Example 1 except that additives having the properties described in the following Table 1 were employed and the same tests as done in Example 1 were performed in the same manner as in Example 1. The features of additives employed are shown in Table 1 and the results of these tests are shown in Table 2.

### COMPARATIVE EXAMPLE 1

To the surface of the toner particle of the same kind as that of Example 1, silica (S1) having, as primary particle, an average particle diameter of 7 nm was applied so as to enable the surface of toner to have a coverage (X) of 25%. At the same time, silica (S2) having, as primary particle, an average particle diameter of 12 nm was added so as to enable the ratio (Y) of total projecting area thereof to become 120% of a total projecting area of the silica (S1).

Then, 0.05% by weight of a metal soap and 0.1% by weight of titanium oxide (which was twice as large as the weight of metal soap) were added to the toner particle having two kinds of silica adhered thereto and mixed together by means of Henschel mixer to obtain a toner. 5 parts by weight of this toner was added to 95 parts by weight of ferrite particle covered with a resin and mixed together by means of tumbling mixer to obtain a two-component developing agent.

By making use of this developing agent, the copying of image was repeated 500000 times in the same manner as in Example 1. As a result, even if there was no problem with respect to image density and the filming of photoreceptor, the scattering of toner was increased due to an insufficient coverage of the surface of toner by the silica (S1). Further, due to small size of the primary particle of the silica (S2), image density was non-uniform.

The features of the additives employed herein are shown in Table 1 and the results of these tests are shown in Table 2.

### COMPARATIVE EXAMPLE 2

To the toner particle of the same kind as that of Example 1, additives having the features shown in the following Table 1 were added to obtain a developing agent.

By making use of this developing agent, the copying of image was repeated 500000 times in the same manner as in Example 1. As a result, due to an excessive degree of coverage of the surface of toner by the silica (S1), the electrification was increased too high, thereby deteriorating image density, and the generation of filming was admitted also in the photoreceptor.

The features of the additives employed herein are shown in Table 1 and the results of these tests are shown in Table 2.

### COMPARATIVE EXAMPLE 3

To the toner particle of the same kind as that of Example 1, additives having the features shown in the following Table 1 were added to obtain a developing agent.

By making use of this developing agent, the copying of image was repeated 500000 times in the same manner as in Example 1. As a result, due to an excessive ratio of the silica (S2) in the ratio in total projecting area between the silica (S1) and the silica (S2), the generation of filming was admitted in the photoreceptor. Further, due to small size of the primary particle of the silica (S1), the electrification was increased too high, thereby deteriorating image density.

The features of the additives employed herein are shown in Table 1 and the results of these tests are shown in Table 2.

### COMPARATIVE EXAMPLE 4

To the toner particle of the same kind as that of Example 1, additives having the features shown in the following Table 1 were added to obtain a developing agent.

By making use of this developing agent, the copying of image was repeated 500000 times in the same manner as in Example 1. As a result, due to an excessive ratio of the silica (S1) in the ratio in total projecting area between the silica (S1) and the silica (S2), image density was deteriorated and image density was non-uniform.

The features of the additives employed herein are shown in Table 1 and the results of these tests are shown in Table 2.

### COMPARATIVE EXAMPLE 5

To the toner particle of the same kind as that of Example 1, additives having the features shown in the following Table 1 were added to obtain a developing agent.

By making use of this developing agent, the copying of image was repeated 500000 times in the same manner as in Example 1. As a result, due to an excessively large size of the primary particle of the silica (S1), the scattering of toner was increased. Further, the effect of the fluidizing agent was deteriorated, thus deteriorating the conveying property of developing agent.

The features of the additives employed herein are shown in Table 1 and the results of these tests are shown in Table 2.

### COMPARATIVE EXAMPLE 6

To the toner particle of the same kind as that of Example 1, additives having the features shown in the following Table 1 were added to obtain a developing agent.

By making use of this developing agent, the copying of image was repeated 500000 times in the same manner as in Example 1. As a result, due to an excessive quantity of the metal soap, the conveying property of developing agent was deteriorated, thereby promoting the non-uniformity in concentration of image. Further, due to a large quantity of titanium oxide, the quantity of floating titanium oxide in the recycle toner was increased, thus promoting the scattering of toner.

The features of the additives employed herein are shown in Table 1 and the results of these tests are shown in Table 2.

### COMPARATIVE EXAMPLE 7

To the toner particle of the same kind as that of Example 1, additives having the features shown in the following Table 1 were added to obtain a developing agent.

By making use of this developing agent, the copying of image was repeated 500000 times in the same manner as in Example 1. As a result, due to an excessively large size of the primary particle of the silica (S2), the photoreceptor was damaged, thereby generating the filming thereof.

The features of the additives employed herein are shown in Table 1 and the results of these tests are shown in Table 2.

### COMPARATIVE EXAMPLE 8

To the toner particle of the same kind as that of Example 1, additives having the features shown in the following Table 1 were added to obtain a developing agent.

By making use of this developing agent, the copying of image was repeated 500000 times in the same manner as in Example 1. As a result, since the quantity of the metal soap was made the same as that of titanium oxide, the conveying property of developing agent was deteriorated, thereby promoting the non-uniformity in concentration of image.

The features of the additives employed herein are shown in Table 1 and the results of these tests are shown in Table 2.

TABLE 1

| | | Diameter of | | | Diameter of | | Ratio of | | |
|---|---|---|---|---|---|---|---|---|---|
| | | primary | | | primary | | projecting | Content of | |
| | | particle of | Content of | Coverage | particle of | Content of | area Y | metal soap | |
| | | S1 (nm) | S1 (wt %) | X by S1 | S2 (nm) | S2 (wt %) | (×100) | (wt %) | Ti oxide |
| Examples | 1 | 10 | 0.30 | 30 | 16 | 0.58 | 120 | 0.05 | 0.1 |
| | 2 | 12 | 0.35 | 30 | 25 | 0.51 | 70 | 0.2 | 0.4 |
| | 3 | 12 | 0.59 | 50 | 16 | 0.95 | 120 | 0.2 | 0.4 |
| | 4 | 15 | 0.73 | 50 | 25 | 0.85 | 70 | 0.05 | 0.1 |
| | 5 | 15 | 0.44 | 30 | 16 | 1.40 | 120 | 0.05 | 0.1 |
| | 6 | 15 | 0.44 | 30 | 25 | 0.51 | 70 | 0.2 | 0.4 |
| | 7 | 15 | 0.73 | 50 | 16 | 0.94 | 120 | 0.2 | 0.4 |
| | 8 | 15 | 0.73 | 50 | 25 | 0.85 | 70 | 0.05 | 0.1 |
| Comp. | 1 | 10 | 0.24 | 25 | 12 | 0.20 | 120 | 0.05 | 0.1 |
| Exs. | 2 | 10 | 0.58 | 60 | 25 | 0.72 | 70 | 0.2 | 0.4 |
| | 3 | 7 | 0.34 | 50 | 16 | 0.62 | 130 | 0.2 | 0.4 |
| | 4 | 12 | 0.59 | 50 | 25 | 0.50 | 60 | 0.05 | 0.1 |
| | 5 | 17 | 0.50 | 30 | 16 | 0.33 | 120 | 0.02 | 0.04 |
| | 6 | 15 | 0.44 | 30 | 25 | 0.37 | 70 | 0.35 | 0.7 |
| | 7 | 15 | 0.73 | 50 | 30 | 1.02 | 120 | 0.02 | 0.04 |
| | 8 | 15 | 0.73 | 50 | 25 | 0.61 | 70 | 0.05 | 0.05 |

TABLE 2

| | | | Non-uni- | | | Developing |
|---|---|---|---|---|---|---|
| | | | formity | Scat- | Filming | agent- |
| | | Image | in image | tering | of photo- | conveying |
| | | density | density | of toner | receptor | property |
| Exam- | 1 | ◯ | ◯ | ◯ | ◯ | ◯ |
| ples | 2 | ◯ | ◯ | ◯ | ◯ | ◯ |
| | 3 | ◯ | ◯ | ◯ | ◯ | ◯ |
| | 4 | ◯ | ◯ | ◯ | ◯ | ◯ |
| | 5 | ◯ | ◯ | ◯ | ◯ | ◯ |
| | 6 | ◯ | ◯ | ◯ | ◯ | ◯ |
| | 7 | ◯ | ◯ | ◯ | ◯ | ◯ |
| | 8 | ◯ | ◯ | ◯ | ◯ | ◯ |
| Comp. | 1 | ◯ | X | X | ◯ | Δ |
| Exs. | 2 | X | ◯ | ◯ | X | ◯ |
| | 3 | X | ◯ | ◯ | X | ◯ |
| | 4 | X | X | ◯ | ◯ | ◯ |
| | 5 | ◯ | ◯ | X | ◯ | Δ |
| | 6 | Δ | X | X | ◯ | X |
| | 7 | ◯ | ◯ | ◯ | X | ◯ |
| | 8 | ◯ | Δ | ◯ | ◯ | X |

As described above, according to the developing agent of the example, it is possible to form an image of high-quality which is stable in electrostatic properties throughout the life thereof and excellent in developing agent-conveying property without deteriorating the denseness of solid image and without generating non-uniformity in concentration of image or scattering of toner even if it is employed in an image-forming apparatus provided with a recycling mechanism.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising a toner particle containing a coloring material and a binder resin; and an additive added to a surface of the toner particle, wherein the additive comprises a first silica whose primary particle has a first mean volume diameter ranging from 10 to 15 nm, and a second silica whose primary particle has a second mean volume diameter which is larger than the first mean volume diameter, a coverage of the first silica to the toner particle adhered with the additive is confined within the range of 30 to 50%, and a ratio of projecting area of the second silica to projecting area of the first silica is confined within the range of 70 to 120%.

2. The developing agent according to claim 1, which further comprises a metal soap applied to the surface of toner particle at a ratio ranging from 0.05 to 0.15% by weight based on a total weight of toner particle.

3. The developing agent according to claim 2, which further comprises titanium oxide applied to the surface of toner particle at a ratio ranging from 1.5 to 2.5 parts by weight per part by weight of metal soap.

4. The developing agent according to claim 1, wherein the mean volume diameter of the second silica is confined within the range of 16 to 25 nm.

5. The developing agent according to claim 1, wherein titanium oxide is applied to the surface of toner particle at a ratio ranging from 0.1 to 0.3% by weight based on a total weight of toner particle.

6. The developing agent according to claim 1, wherein titanium oxide has an mean volume diameter ranging from 14 nm to 25 nm.

7. A toner supply container housing a developing agent comprising a toner particle containing a coloring material and a binder resin; and an additive added to a surface of the toner particle, wherein the additive comprises a first silica whose primary particle has a first mean volume diameter ranging from 10 to 15 nm, and a second silica whose primary particle has a second mean volume diameter which is larger than the first mean volume diameter, a coverage of the first silica to the toner particle adhered with the additive is confined within the range of 30 to 50%, and a ratio of projecting area of the second silica to projecting area of the first silica is confined within the range of 70 to 120%.

8. The toner supply container according to claim 7, which further comprises a metal soap applied to the surface of toner particle at a ratio ranging from 0.05 to 0.15% by weight based on a total weight of toner particle.

9. The toner supply container according to claim 8, which further comprises titanium oxide applied to the surface of toner particle at a ratio ranging from 1.5 to 2.5 parts by weight per part by weight of metal soap.

10. The toner supply container according to claim 7, wherein the mean volume diameter of the second silica is confined within the range of 16 to 25 nm.

11. The toner supply container according to claim 7, wherein titanium oxide is applied to the surface of toner particle at a ratio ranging from 0.1 to 0.3% by weight based on a total weight of toner particle.

12. The toner supply container according to claim 7, wherein titanium oxide has an mean volume diameter ranging from 14 nm to 25 nm.

13. An image forming apparatus comprising:
a image carrier to hold electrostatically a developing agent image;
a developing device having a developing agent carrying part to carry the developing agent
and supply the developing agent to the image carrier, and a developing agent container to house the developing agent, and a recycling mechanism to recover an used developing agent and supply the used developing agent to the developing agent container,
wherein the developing agent comprises a toner particle containing a coloring material and a binder resin; and an additive added to a surface of the toner particle, in which the additive includes a first silica whose primary particle has a first mean volume diameter ranging from 10 to 15 nm, and a second silica whose primary particle has a second mean volume diameter which is larger than the first mean volume diameter, a coverage of the first silica to the toner particle adhered with the additive is confined within the range of 30 to 50%, and a ratio of projecting area of the second silica to projecting area of the first silica is confined within the range of 70 to 120%.

14. The image forming apparatus according to claim 13, wherein the image carrier and the developing device are held integrally as a processing cartridge removable from the image forming apparatus.

15. The image forming apparatus according to claim 13, which further comprises a metal soap applied to the surface of toner particle at a ratio ranging from 0.05 to 0.15% by weight based on a total weight of toner particle.

16. The image forming apparatus according to claim 14, which further comprises titanium oxide applied to the surface of toner particle at a ratio ranging from 1.5 to 2.5 parts by weight per part by weight of metal soap.

17. The image forming apparatus according to claim 13, wherein the mean volume diameter of the second silica is confined within the range of 16 to 25 nm.

18. The image forming apparatus according to claim 13, wherein titanium oxide is applied to the surface of toner particle at a ratio ranging from 0.1 to 0.3% by weight based on a total weight of toner particle.

19. The image forming apparatus according to claim 13, wherein titanium oxide has an mean volume diameter ranging from 14 nm to 25 nm.
